(19) United States
(12) Patent Application Publication
(10) Pub. No.: US 2010/0198455 A1
(43) Pub. Date: Aug. 5, 2010

(54) INFORMATION DISTRIBUTING SYSTEM AND VEHICLE-MOUNTED DEVICE

(75) Inventors: Nobuyuki Hotta, Hachiouji (JP); Kouji Kuga, Sagamihara (JP); Hideo Shimoshimano, Hachiouji (JP)

Correspondence Address: Robinson Intellectual Property Law Office, P.C., 3975 Fair Ridge Drive, Suite 20 North, Fairfax, VA, 22033, US

(73) Assignee: Kabushiki Kaisha Kenwood, Hachiouji-shi, Tokyo (JP)

(21) Appl. No.: 12/679,559

(22) PCT Filed: Sep. 25, 2008
(86) PCT No.: PCT/JP2008/067227

§ 371 Date: Mar. 23, 2010

(30) Foreign Application Priority Data
Sep. 28, 2007 (JP) 2007-254183

(51) Int. Cl. G06F 19/00

(52) U.S. Cl. 701/33

(57) ABSTRACT

An information distributing system and a vehicle-mounted device that are able to distribute or acquire information related to vehicle maintenance. The information distributing system comprises vehicle-mounted devices (10) and a center apparatus (30). Each vehicle-mounted device (10) includes a communication part (3b) that communicates with the center apparatus (30) via a roadside apparatus (20); a storing part (3c) that stores uplink information including information related to the driving of a target vehicle (C); and a control part (4) that causes the uplink information to be transmitted to the center apparatus (30). The center apparatus (30) includes a communication part (35) that communicates with the vehicle-mounted devices (10) via roadside apparatuses (20); a storing part (34) that manages and stores maintenance history information related to the maintenance of the target vehicle (C) for each vehicle-mounted device (10); and a control part (31) that produces, based on both the uplink information received via the communication part (35) and the maintenance history information stored by the storing part (34), maintenance notification information for notifying a maintenance timing for each vehicle-mounted device (10) and that causes the maintenance notification information to be transmitted to the vehicle-mounted device (10).

### TECHNICAL FIELD

The present invention relates to an information distributing system and vehicle-mounted device.

### BACKGROUND ART

At present, a car navigation system, where an ITS (Intelligent Transport System) vehicle-mounted device comprising a navigation device is mounted on a vehicle, provides various services including ETC (Electronic Toll Collection system) and the VICS (Vehicle Information and Communication System).

In recent years, a wireless communication system referred to as DSRC (Dedicated Short-Range Communication) has been adopted, thereby attempting to provide various services. In terms of providing such services, it is premised that a roadside apparatus capable of DSRC connection and a center apparatus can communicate with each other via a network.

The roadside apparatus is disposed at each of prescribed points, and communicates with the vehicle-mounted device via the DSRC connection. On this occasion, the vehicle-mounted device transmits cumulative driving distance information (uplink information), which has preliminarily been produced, to the roadside apparatus.

The center apparatus provides the vehicle-mounted device with required services on the basis of uplink information received via the roadside apparatus. The uplink information includes unique information varying among the vehicle-mounted devices.

DSRC allows advertisement information closely related to local areas to be displayed on a screen of the navigation device in real time, in addition to realization of the aforementioned ETC and VICS. This is because the services provided by the center apparatus is based on the uplink information transmitted from the vehicle-mounted device.

The advertisement information closely related to local areas includes, for example, information on various facilities such as restaurants and parking lots near the target vehicle. Such information distributing services using DSRC allow a user to view only required advertisement information near the target vehicle (see Patent Documents 1 and 2).

Patent Document 1: Japanese Patent Application Laid-Open No. 2001-101578.

Patent Document 2: Japanese Patent Application Laid-Open No. 2004-279509.

### DISCLOSURE OF THE INVENTION

### Problems to be Solved by the Invention

However, the information distributed by the aforementioned information distributing services is oriented to the general public and is not necessarily useful information for an individual user. More specifically, information pertaining to maintenance including inspection timing such as the official safety checkout of a car and exchange timing of consumables such as oil and tires varies among vehicles. The user is unable to receive such information.

The object of the present invention is to provide an information distributing system and a vehicle-mounted device that can distribute and acquire information pertaining to vehicle maintenance.

### Means for Solving the Problem

An aspect of the present invention provides an information distributing system in which a vehicle-mounted device is mounted on each of one or more vehicles and connected to a center apparatus via a roadside apparatus in a manner capable of making wireless communication,

wherein the vehicle-mounted device comprises: first communication means for communicating with the center apparatus via the roadside apparatus; first storage means for storing driving information of the vehicle mounted with the vehicle-mounted device; and first control means for reading the driving information from the first storage means and causing the first communication means to transmit the information to the center apparatus; and

the center apparatus comprises: second communication means for communicating with the vehicle-mounted device via the roadside apparatus; second storage means for storing maintenance history information of the vehicle in association with the vehicle-mounted device mounted on the vehicle; and second control means for producing maintenance notification information for notifying maintenance timing of the vehicle on the basis of the driving information transmitted from the vehicle-mounted device and the maintenance history information read from the second storage means and causing the second communication means to transmit the produced maintenance notification information to the vehicle-mounted device of the vehicle.

The driving information may include date and time data and cumulative driving distance data.

In the information distributing system according to the present invention, the maintenance history information includes a history of inspection timing when an inspection has previously been executed, and the second control means produces maintenance notification information for notifying inspection timing of the vehicle on the basis of the driving information and the maintenance history information and causes the second communication means to transmit the produced maintenance notification information to the vehicle-mounted device.

In the information distributing system according to the present invention, the maintenance history information includes an exchange history of exchanging consumables of the vehicle, and the second control means produces maintenance notification information for notifying timing of exchanging consumables of the vehicle on the basis of the cumulative driving distance information and the maintenance history information and causes the second communication means to transmit the produced maintenance notification information to the vehicle-mounted device of the vehicle.

In the information distributing system according to the present invention, wherein the vehicle-mounted device comprises display means, and the first control means causes the display means to display the maintenance notification information transmitted from the center apparatus.

In the information distributing system according to the present invention, the first control means causes the first storage means to temporarily store the maintenance notification information transmitted from the center apparatus, and causes the display means to display the information after a lapse of a prescribed time period.

A further aspect of the present invention provides a vehicle-mounted device mounted on each of one or more vehicles and connected to a center apparatus via a roadside apparatus in a manner capable of making wireless communication the vehicle-mounted device, comprising:

communication means for communicating with the center apparatus via the roadside apparatus;

storage means for storing driving information of the vehicle mounted with the vehicle-mounted device; and

control means for reading the driving information from the storage means and causing the communication means to transmit the information to the center apparatus.

### EFFECTS OF THE INVENTION

According to the present invention, the center apparatus can produces the maintenance notification information for notifying the maintenance timing with respect to each vehicle-mounted device on the basis of the cumulative driving distance information and the maintenance history information, and distribute the information. The vehicle-mounted device can acquire the maintenance notification information produced by the center apparatus via the wireless communication.

Since each vehicle-mounted device can acquire the maintenance notification information produced with respect to each vehicle-mounted device, a user can easily grasp the state of the vehicle, and execute an inspection and exchange of the consumables without forgetting. This can prevent the vehicle from causing a sudden malfunction.

### BRIEF DESCRIPTION OF THE DRAWINGS

FIG. 1 is an overall configuration diagram showing an example of an information distributing system;

FIG. 2 is a diagram showing an example of a basic configuration of DSRC communication;

FIG. 3 is a functional block diagram of a vehicle-mounted device;

FIG. 4 is a diagram showing an example of a data configuration of uplink information;

FIG. 5 is a functional block diagram of a center apparatus;

FIG. 6 is a diagram showing an example of tables in a database;

FIG. 7 is a flowchart illustrating processing operation of the entire information distributing system;

FIG. 8 is a flowchart illustrating a process of transmitting maintenance notification information; and

FIG. 9 is a flowchart illustrating a process of displaying maintenance notification information of an accumulation type on a display unit.

### DESCRIPTION OF SYMBOLS

100 information distributing system
10 vehicle-mounted device
20 roadside apparatus
30 center apparatus
1 car navigation unit
2 VICS module
3 DSRC unit
4, 31 control unit
C target vehicle

### BEST MODES FOR CARRYING OUT THE INVENTION

The configuration and operation of a most preferred embodiment of a vehicle-mounted device according to the present invention will hereinafter be described in detail with reference to the drawings.

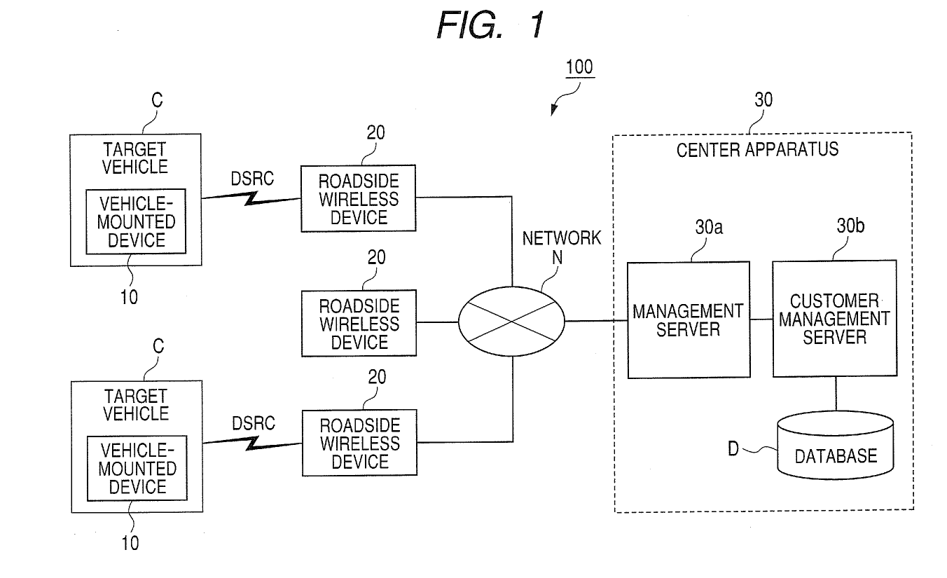

FIG. 1 shows the overall diagram of the information distributing system 100 of this embodiment.

The information distributing system 100 comprises a vehicle-mounted device 10, a roadside apparatus 20 and a center apparatus 30.

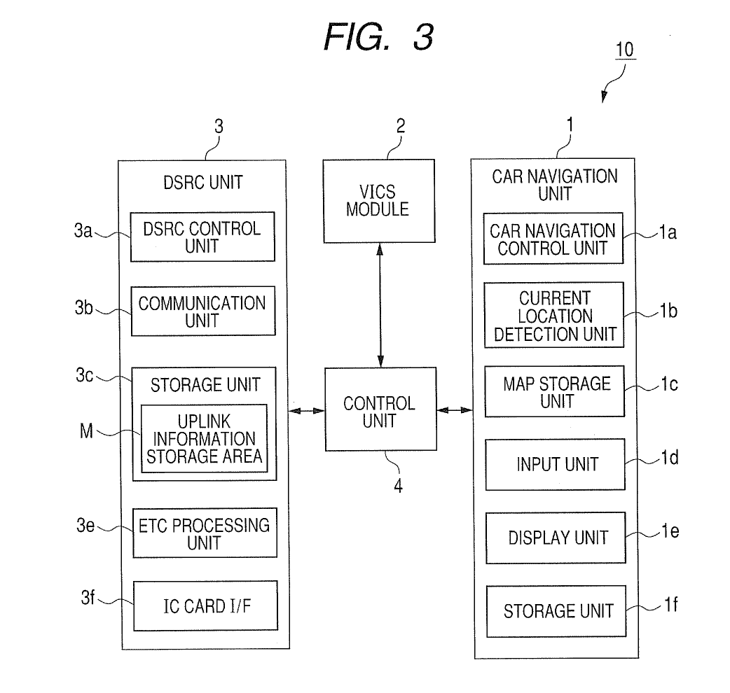

The vehicle-mounted device 10 includes a car navigation unit and a DSRC unit (see FIG. 3) and installed at a prescribed position in a target vehicle C.

The car navigation unit can receive services such as VICS mainly via three media, which are an FM multiplex broadcast, an optical beacon and a radio beacon. Up to the present, the services have been provided such that various pieces of information are unidirectionally received by the vehicle-mounted device 10 with respect to each of these media.

On the other hand, the DSRC unit is capable of active type two-way communication using the 5.8 GHz band, which is for example used in ETC.

The roadside apparatuses 20 are disposed on roads and in parking lots, and interactively communicate with the DSRC unit of the vehicle-mounted device 10 using the 5.8 GHz band. The communication distance is reduced to several meters to several tens of meters to reduce the radii of cells, thereby allowing reliable communication with each of the vehicle-mounted devices 10.

This, for example, prevents the roadside apparatus 20 from receiving a radio wave from the DSRC unit of a vehicle other than that passing through a tollgate on a turnpike to interfere with correct billing.

Further, the same 5.8 GHz band is used in every small sector, thereby effectively utilizing frequency resources. Moreover, services closely related to places where users are, such as local information and meteorological information, can be provided.

The center apparatus 30 stores information to provide for the vehicle-mounted device 10. The center apparatus 30 is connected with the roadside apparatus 20 via a network N. When the vehicle-mounted device and the roadside apparatus 20 initiate two-way communication with each other via the DSRC, the center apparatus 30 is notified of initiation of connection by the roadside apparatus 20. The center apparatus 30 transmits required information requested by the vehicle-mounted device 10 to the roadside apparatus 20. The vehicle-mounted device 10 then receives this information.

The center apparatus 30 comprises a management server 30a and a customer management server 30b.

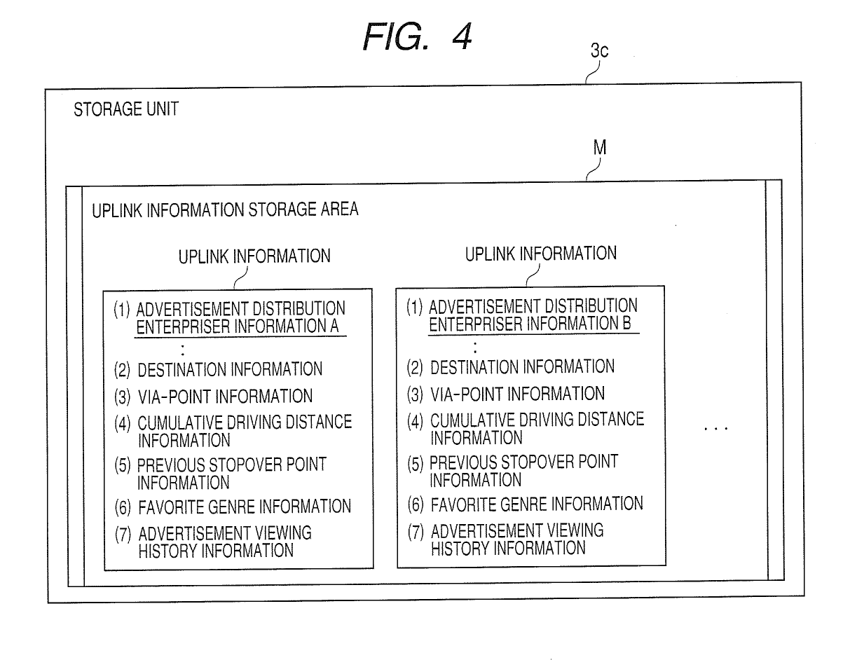

The management server 30a manages cumulative driving distance information (hereinafter referred to as “uplink information” (see FIG. 4)) transmitted from the vehicle-mounted device 10, and transmits required uplink information to the customer management server 30b.

The customer management server 30b is disposed on a store-by-store basis, produces required information according to contract contents of a user on the basis of the uplink information received from the management server 30a, and transmits this information to the vehicle-mounted device 10.

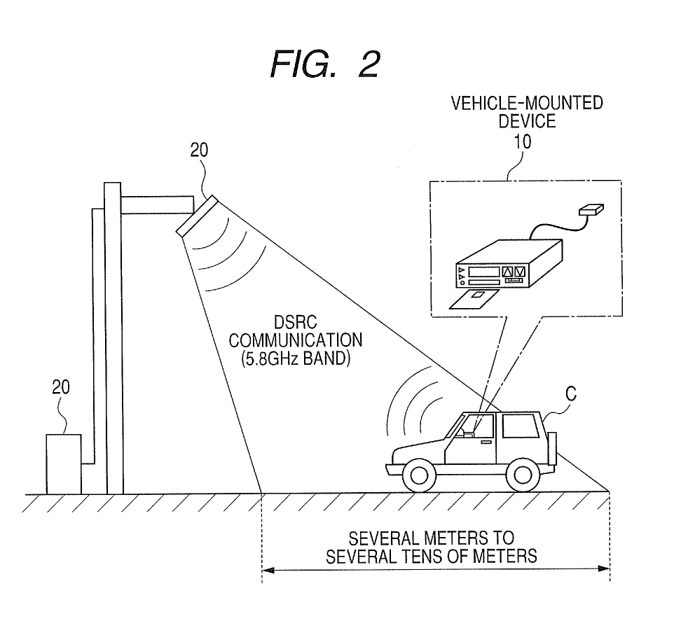

FIG. 2 shows an example of a basic configuration of the DSRC communication between the vehicle-mounted device 10 and the roadside apparatus 20.

In the case here, the target vehicle C, which includes the vehicle-mounted device 10, is traveling in a low speed or stopped in order to cause the center apparatus 30 and the vehicle-mounted device 10 to communicate with each other in a one-to-one correspondence. When the target vehicle C is in an area capable of communicating with the roadside apparatus 20, the roadside apparatus 20 initiates two-way wireless communication with the vehicle-mounted device 10. The area capable of communicating is a region whose cell radius is about several meters to several tens of meters, as described above.

FIG. 3 shows a functional block diagram of the vehicle-mounted device 10.

If viewed broadly, the vehicle-mounted device 10 comprises a car navigation unit 1, a VICS module 2, a DSRC unit 3 and a control unit 4. Typically, these may collectively be referred to as an ITS vehicle-mounted device.

The car navigation unit 1 mainly comprises a car navigation control unit 1a, a current location detection unit 1b, a map storage unit 1c, an input unit 1d, a display unit 1e and storage unit 1f.

The car navigation control unit 1a receives the current location of the target vehicle C outputted from the current location detection unit 1b. The car navigation control unit 1a matches the location to the geometry of roads in map data outputted from the map storage unit 1c, and causes the display unit 1e to display a map screen and a current own vehicle mark. The control unit 1a, while displaying the own vehicle mark, performs route guidance to a destination set by the user.

The input unit 1d includes hard key buttons such as various keys for inputting designation on navigation operations and keys for instructions of switching audio menu displays, and outputs operation signals according to these key operations to the car navigation control unit 1a.

The display unit 1e comprises a monitor and/or a touch panel. The display unit 1e comprises an LCD (Liquid Crystal Display) or the like, and performs a display process according to display signals inputted from the car navigation control unit 1a.

The storage unit 1f comprises a recording medium preliminary stored with programs, data and the like. The storage unit 1f stores various control programs performed by the car navigation control unit 1a and data used when these control programs are performed, on the recording medium.

The VICS module 2 mainly comprises a module having three VICS functions, and receives congestion information and emergency information. The three VICS functions are an optical beacon via optical communication, an FM multiplex broadcast via FM communication and a radio beacon via radio communication.

The optical beacon receives information providing services on ordinary roads using infrared rays. Since the maximum communication distance of 3.5 m is short, individual information can separately be received on a lane-by-lane basis. This can also be used for two-way communication. The optical beacons are managed by the National Police Agency.

The FM multiplex broadcast can be received at any place where radio waves from local FM broadcasting stations can be received.

The radio beacon uses radio waves in the 2.4 GHz band and mainly receives information providing services on turnpikes. The maximum communication distance is about 70 m and the data transmission speed of 64 kbit/s is low. (There is a plan to shift the frequency band used for the radio beacon from 2.4 GHz band to 5.8 GHz band and integrate it with the DSRC after the fiscal year 2007.) Use of the DSRC increases the data transmission speed to 4 Mbit/s and enables two-way communication.

The DSRC unit 3 comprises a DSRC control unit 3a, a communication unit 3b, a storage unit 3c, ETC processing unit 3e and an IC card I/F unit 3f.

The DSRC control unit 3a performs centralized control by cooperation with various control programs stored in the storage unit 3c of controlling each element of the DSRC unit 3 and controlling communication and the like. The DSRC control unit 3a stores the uplink information, which will be described later, in the storage unit 3c. The DSRC control unit 3a transmits the uplink information to the roadside apparatus 20 via the communication unit 3b.

The communication unit 3b comprises an aerial wire unit, which is not shown, and receives RF (Radiology Frequency) signals in the frequency band of 5.8 GHz. The communication unit 3b demodulates the received RF signals and transmits the signals to the DSRC control unit 3a. On the other hand, the communication unit 3b receives data transmitted from the DSRC control unit 3a and outputs the data via the aerial wire unit. The outputted data is to be transmitted to the roadside apparatus 20.

The storage unit 3c comprises a recording medium preliminary stored with various programs, data and the like. The storage unit 3c stores various control programs to be performed by the DSRC control unit 3a and data used when these control programs are performed.

The storage unit 3c includes an uplink information storage area M.

Here, uplink information stored in the uplink information storage area M will be described with reference to FIG. 4.

The uplink information storage area M is stored with various pieces of information on (1) advertisement distribution enterpriser information, (2) destination information, (3) via-point information, (4) cumulative driving distance information, (5) previous stopover point information, (6) favorite genre information, and (7) advertisement viewing history information. Among the aforementioned (1)-(7) information pieces, (2)-(5) are information pieces pertaining to travel of the vehicle.

In a following description, the control unit 4 produces this information as uplink information, and stores the information in the uplink information storage area M. However, without any restriction thereto, the car navigation control unit 1a or the DSRC control unit 3a may each store the information in the uplink information storage area M.

The information stored in the uplink information storage area M is transmitted to the center apparatus 30. More specifically, the uplink information temporarily stored in the management server 30a, and subsequently transmitted to the customer management server 30b.

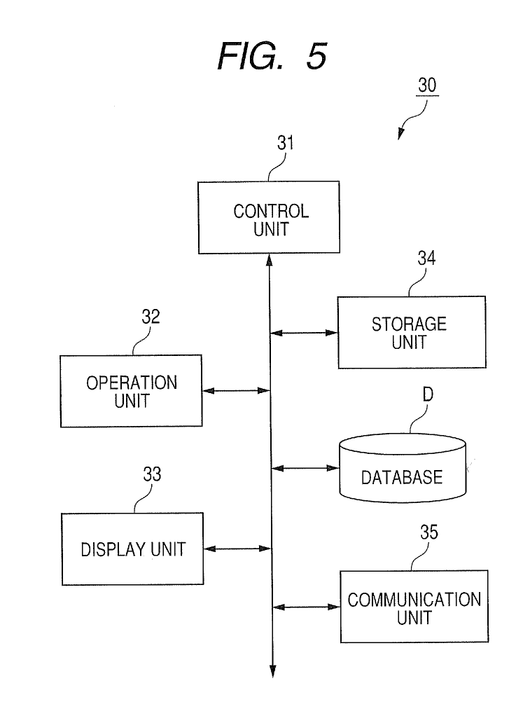

The customer management server 30b produces maintenance notification information for notifying the user of maintenance timing on the basis of the uplink information and maintenance history information, which has preliminarily been stored in the customer management server 30b. The maintenance history information will be described later in illustration of FIG. 5.

The produced maintenance notification information is to be transmitted to the vehicle-mounted device 10. The vehicle-mounted device 10 is to display the maintenance notification information on the display unit 1e.

The pieces of information configuring the uplink information will be described hereinafter. Each piece of information, to be described below, may be capable of being individually set via the input unit 1d by the user whether or not each piece is produced as the uplink information and stored. In this embodiment, the customer management server 30b mainly uses (4) the cumulative driving distance information among the following uplink information when producing the maintenance notification information.

(1) The advertisement distribution enterpriser information is identification information for identifying an advertisement distribution enterpriser that provides the information providing service. In a case where the user contracts with a plurality of advertisement distribution enterprisers, the uplink information of (2)-(7) is stored in the uplink information storage area M with respect to each advertisement distribution enterpriser. In FIG. 4, the uplink information of (2)-(7) is stored in each of advertisement distribution enterpriser information A and advertisement distribution enterpriser information B.

(2) The destination information is latitude and longitude information at the destination set in the car navigation unit 1, and information on travel of the target vehicle C.

(3) The via-point information is latitude and longitude information at points, e.g. five points at the maximum, set in the car navigation unit 1. The information is also on the travel of the target vehicle C, as with (2).

The user can view information distributed on the basis of information of (2) and (3) through the display unit 1e. This allows the user to view various pieces of information on the destination and its vicinity and via-points and their vicinities up to the destination.

(4) The cumulative driving distance information is on the cumulative driving distance of the target vehicle C mounted with the vehicle-mounted device 10.

The control unit 4 stores the cumulative driving distance having been stored in the car navigation unit 1 as the uplink information. This allows the user to view, for example, information on gas stations through the display unit 1e. If the information of (4) is combined with the information of (2) and (3) and the user allowed to view information distributed on the basis of the combined information, the user can view information on the gas stations at the destination and its vicinity and via-points and their vicinities.

(5) The previous stopover point information is that storing latitude, longitude and time information of the target vehicle C, e.g. at 128 points at the maximum, when the power supply of the vehicle-mounted device 10 has been terminated. When the previous stopover point information, which the DSRC control unit 3a stores until transmitting the uplink information to the roadside apparatus 20, becomes that on 128 points or more, the previous stopover point information is overwritten from its older part. After transmission to the roadside apparatus 20, the previous stopover point information is reset. The timing when the DSRC control unit 3a writes the previous stopover point information as the uplink information into the storage unit 3c is not restricted to that immediately before the power supply is terminated. Instead, the timing may be that immediately after the power supply is turned ON. This information is to be stored as information on the travel of the target vehicle C, in the uplink information storage area M. A part of this information is also used as (7) the advertisement viewing information, which will be described later.

(6) The favorite genre information can be inputted by the user via the input unit 1d with respect to the favorite genre, and is on information desired to be distributed. The control unit 4 stores the inputted favorite genre information in the uplink information storage area M. The control unit 4 then performs control so as not to permit reception of advertisement information other than the favorite genre information among information transmitted from the roadside apparatus 20.

Accordingly, the user can be kept away from viewing unnecessary advertisement information. On the other hand, the advertisement distribution enterprisers can distribute required advertisement information on a user-by-user basis.

(7) The advertisement viewing information is that storing information of whether the distributed information has been received or not, information indicating whether the received advertisement information has been displayed on the display unit 1e or not, and information indicating whether or not the user has stopped the target vehicle C at a location referred in the advertisement information on the basis of the displayed information. The information indicating whether received or not and the information indicating whether displayed or not includes information on time.

Referring again to FIG. 3, the ETC processing unit 3e exchanges information required to balance a bill with a toll gate via wireless communication in the 5.8 GHz band. The required information includes information about the target vehicle C, an entrance tollgate, an exit tollgate, and a toll. The ETC processing unit 3e reads and writes the information from and into an IC card inserted in the IC card I/F unit 3f.

The IC card I/F unit 3f stores the IC card preliminarily stored with card-specific information in a manner capable of insertion and extraction. The ETC processing unit 3e acquires the information stored in the IC card via the IC card I/F unit 3f with respect to information required when using ETC. The history of tolls and the like can be stored in the IC card. The ETC processing unit 3e writes the history via the IC card I/F unit 3f.

The control unit 4 controls the car navigation unit 1, the VICS module 2 and the DSRC unit 3, which have been described above, in a centralized manner. For example, the control unit 4 instructs the DSRC control unit 3a to store the destination information, the via-point information and the like produced by the car navigation unit 1 in the storage unit 3c. When the DSRC unit 3 initiates the DSRC connection with the roadside apparatus 20, the control unit 4 notifies initiation of communication by transmitting a connection signal to the car navigation unit 1.

FIG. 5 illustrates the internal configuration of the center apparatus 30.

Since the management server 30a and the customer management server 30b have the similar configuration, the customer management server 30b will here be described as a typical case.

The customer management server 30b comprises a control unit 31, an operation unit 32, a display unit 33, a storage unit 34 and a communication unit 35.

The control unit 31 comprises a CPU (Central Processing Unit) and a RAM (Random Access Memory), and loads prescribed programs stored in the storage unit 34 into the RAM and controls processing operations in a centralized manner by cooperation with the programs.

The operation unit 32 comprises a keyboard including numeric keys, character keys and function keys, and a mouse, and outputs operation signals according to the operated keys to the control unit 31.

The display unit 33 comprises an LCD (Liquid Crystal Display), and displays various pieces of display information, such as an operation screen, according to display control by the control unit 31. The display unit 33 may adopt a mode configured into an integrated touch panel with the operation unit 32.

The storage unit 34 includes various programs, such as control programs to be executed by the control unit 31 and maintenance notification information producing program, in addition to system programs; stores various parameters required to execute the respective programs; and stores processed data and the like after execution.

The database D is a database of the maintenance history information managed on each vehicle-mounted device 10 basis and the customer list information.

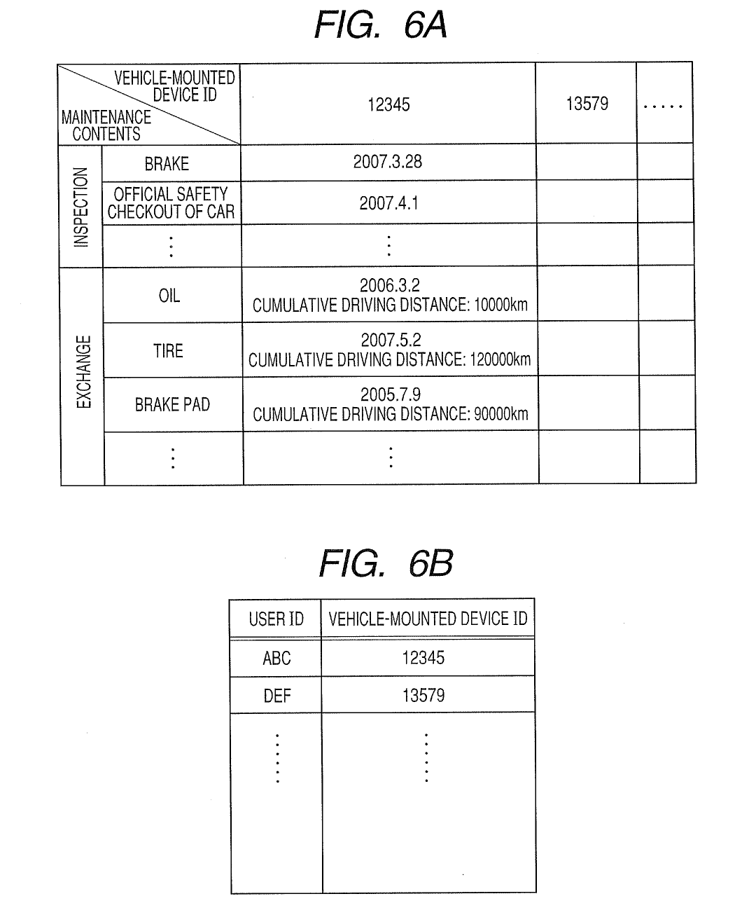

Tables of the maintenance history information and the customer management list in the database D will here be described with reference to FIG. 6.

FIG. 6 (a) shows a table of the maintenance history information. The maintenance history information is managed with respect to a vehicle-mounted device ID on each vehicle-mounted device 10 basis. Date information at the last inspection and cumulative driving distance data when at the last time of exchanging consumables are stored as driving information.

If viewed broadly, the maintenance history information comprises inspection histories and exchange histories. The inspection history is a history on timing and contents where the target vehicle C has previously been subjected to inspections and the official safety checkout of a car. The exchange history is a history on timing and contents where the consumables of the target vehicle C have been exchanged. As shown in FIG. 6 (a), the consumables of the target vehicle C includes, for example, oil, tires and brake pads.

FIG. 6 (b) shows a table of the customer list.

The customer list is a list of the names or IDs of users having some kind of contracts with stores having the customer management server 30b. The table of the customer list associates these to vehicle-mounted device IDs. The vehicle-mounted device ID is a unique number defined on each vehicle-mounted device 10.

As will be described later, the customer management server 30b collates the vehicle-mounted device ID corresponding to the user ID, from the user ID assigned to the uplink information, on the basis of the table of the customer list shown in FIG. 6 (b). Further, the customer management server 30b collates the maintenance history information corresponding to the vehicle-mounted device ID, on the basis of the table of management history information shown in FIG. 6 (a).

The communication unit 35 comprises an interface for communication such as a network interface card and a modem.

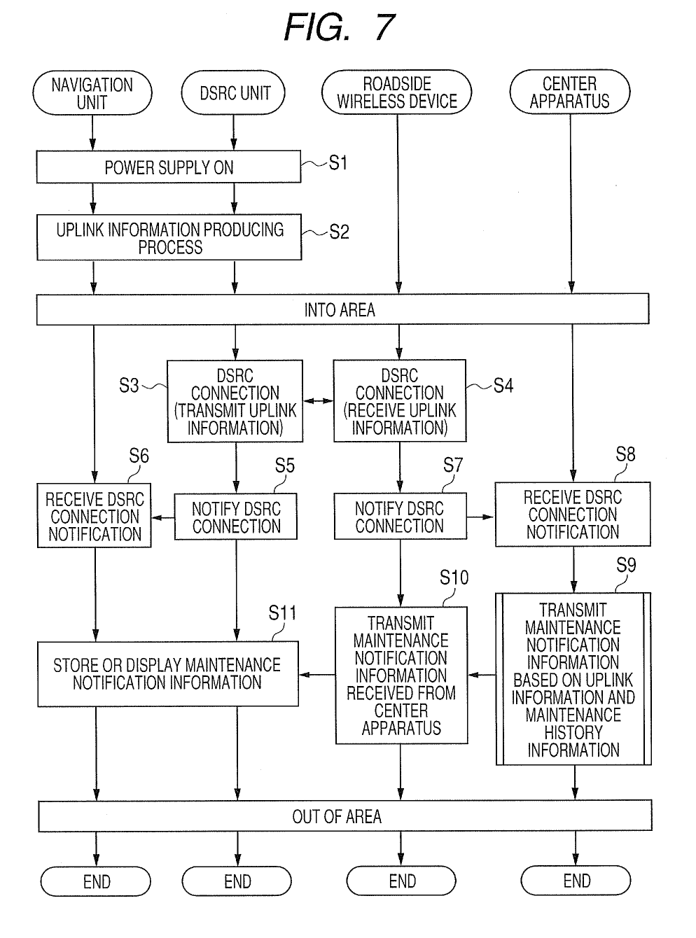

Next, processing operation of the entire information distributing system will be described with reference to FIG. 7.

When the power supply of the vehicle-mounted device 10 is turned ON (step S1), the car navigation unit 1 and the DSRC unit 3 performs a process of storing the uplink information in the uplink information storage area M (step S2). The uplink information produced here is (5) the previous stopover point information (see FIG. 4). As to information capable of being produced even not in a DSRC-connectable area, the information of (1)-(6) in FIG. 4 is successively produced by the control unit 4 and stored in the uplink information storage area M. The stored information is saved as the uplink information for a prescribed time period.

When the vehicle-mounted device 10 (target vehicle C) enters into an area capable of communicating with the roadside apparatus 20, the DSRC unit 13 initiates DSRC connection with the roadside apparatus 20. Here, the uplink information preliminarily stored by a process in step S2 is transmitted to the roadside apparatus 20 (step S3), and the roadside apparatus 20 receives the information (step S4).

The control unit 4 notifies the car navigation unit 1 of initiation of the DSRC connection (step S5), and the car navigation unit 1 receives the notification (step S6).

On the other hand, the roadside apparatus 20 notifies the center apparatus 30 of the initiation of the DSRC connection and transmits the uplink information to the center apparatus 30 (step S7).

The center apparatus 30 receives the DSRC connection notification and the uplink information transmitted from the roadside apparatus 20 via the network N (step S8).

The center apparatus 30 transmits a piece of information determined to be required among the pieces of information stored in the center apparatus 30 to roadside apparatus 20 on the basis of the received uplink information (step S9).

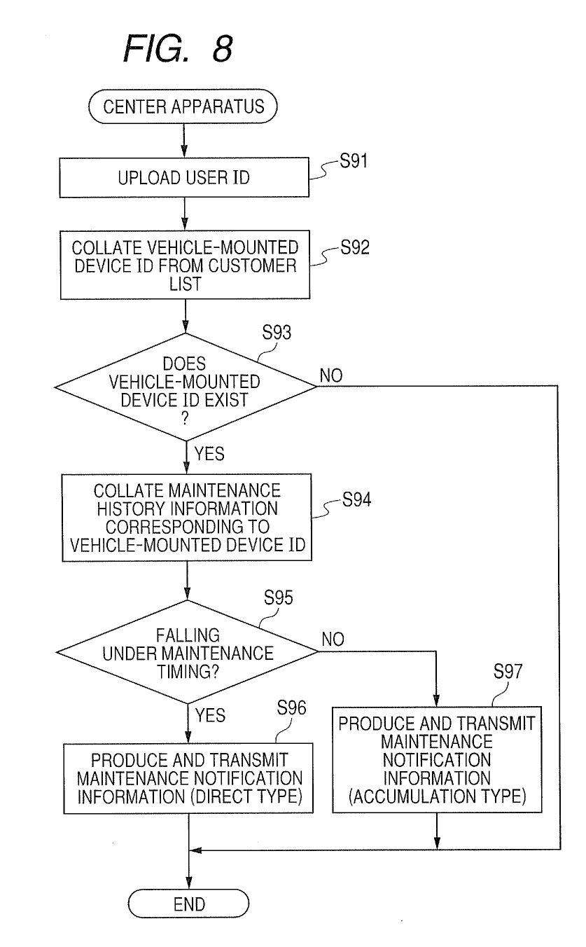

Here, the center apparatus 30 performs a process of identifying the received uplink information, and produces the maintenance notification information corresponding to the uplink information. The center apparatus 30 then performs a process of transmitting the produced maintenance notification information to the roadside apparatus 20. The process here will hereinafter be described with reference to FIG. 8.

FIG. 8 shows a process of transmitting the maintenance notification information performed by the center apparatus 30. This transmitting process is performed by the customer management server 30b.

The customer management server 30b acquires the user ID of the uplink information stored in the management server 30a (step S91). The user ID is a unique identification information assigned to each uplink information.

The customer management server 30b collates the vehicle-mounted device ID from the acquired user ID (step S92). Here, the customer management server 30b refers to the table of the customer list in the database D (see FIG. 6 (b)). The customer management server 30b determines whether the vehicle-mounted device ID corresponding to the acquired user ID exists or not (step S93).

When determining that there is no vehicle-mounted device ID corresponding to the user ID (step S93; NO), the customer management server 30b terminates this process without providing the vehicle-mounted device 10 with the maintenance notification information service.

On the other hand, when determining that there is the vehicle-mounted device ID corresponding to the user ID (step S93; YES), the customer management server 30b acquires the uplink information corresponding to the user ID from the management server 30a. The customer management server 30b executes a collation process on the maintenance history information corresponding to the vehicle-mounted device ID from the database D (step S94). In the maintenance history information, there are recorded, as histories, the inspection timing such as the official safety checkout of a car and the timing of exchanging consumables, as described above.

The customer management server 30b determines whether the target vehicle C is in the maintenance timing or not on the basis of the uplink information acquired from the management server 30a and the aforementioned collated maintenance history information (step S95). The uplink information used for the determination here is, more specifically, (4) the cumulative driving distance information. The maintenance timing here includes the inspection timing and the exchange timing.

The determination of whether the target vehicle C is in the inspection timing or not is made based on whether a time period between the last date and time when the inspection has been executed on the target vehicle C and the date and time when the uplink information has been acquired this time is longer than a prescribed time period or not.

The determination of whether the consumables of the target vehicle C are in the exchange timing or not is made based on whether a difference between the cumulative driving distance of the target vehicle C at the last exchange of the consumables and (4) the cumulative driving distance of the uplink information having been acquired this time exceeds a prescribed distance or not. The prescribed distance varies among the consumables.

When determining that the target vehicle C falls under the maintenance timing (step S95; YES), the customer management server 30b produces the maintenance notification information for notifying that it is in the maintenance timing, and transmits the information to the management server 30a (step S96).

On reception of the maintenance notification information, the vehicle-mounted device 10 determines whether the received information is in a direct type format or in an accumulation type format, and displays or stores the information concerned.

Here, the direct type is that the information is directly displayed when the vehicle-mounted device 10 receives the information. In contrast to that, there is the accumulation type. As to the accumulation type, the information concerned is not directly displayed after the vehicle-mounted device 10 receives the information. Instead, the information is temporarily stored in the storage unit 3c, and displayed after lapse of a prescribed time period. When the accumulation type information having so far been accumulated exceeds the storage capacity of the storage unit 3c, the information may be deleted from its older part.

On the other hand, when determining that the target vehicle C does not fall under the maintenance timing (step S95; NO), the customer management server 30b produces the maintenance notification information for notifying that the vehicle is in the maintenance timing, and transmits the information to the management server 30a (step S97).

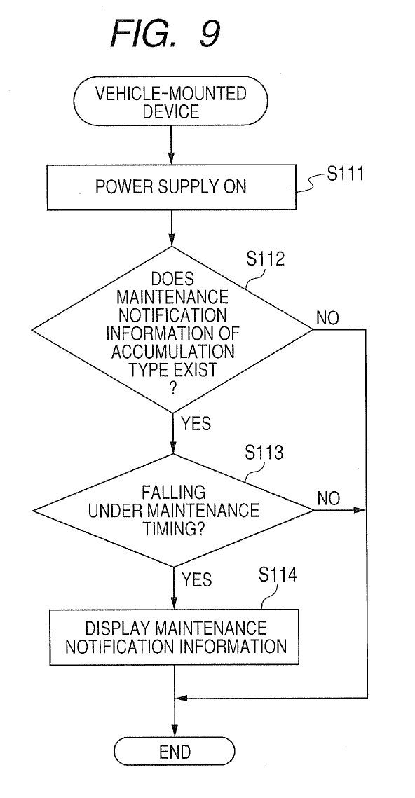

On transmission of the maintenance notification information in the step S97, the customer management server 30b includes a prescribed setting value in the produced maintenance notification information of the accumulation type and subsequently performs a transmission process. The vehicle-mounted device 10, which has received the maintenance notification information, determines whether the target vehicle C is in the maintenance timing or not on the basis of this prescribed setting value. This will be described in the illustration on FIG. 9.

The management server 30a receives the maintenance notification information produced as any one of the direct type and the accumulation type and subsequently transmits the maintenance notification information to the roadside apparatus 20 (steps S96 and S97), and finishes this process.

Referring again to FIG. 7, the roadside apparatus 20 receives the maintenance notification information transmitted from the center apparatus 30, and transmits the received maintenance notification information to the vehicle-mounted device 10 (step S10).

The vehicle-mounted device 10 receives the maintenance notification information from the roadside apparatus 20, and displays the maintenance notification information on the display unit 1e when the received maintenance notification information is the direct type. On the other hand, the vehicle-mounted device 10 stores the maintenance notification information in the storage unit 3c when the received maintenance notification information is the accumulation type (step S11).

When the vehicle-mounted device 10 moves out of the area DSRC-connectable with the roadside apparatus 20, the DSRC connection between the vehicle-mounted device 10 and roadside apparatus 20 is terminated, and this process is finished.

Here, a process until the vehicle-mounted device displays the maintenance notification information of the accumulation type on the display unit 1e, with reference to FIG. 9. For illustrating a process in FIG. 9, it is premised that the power supply of the vehicle-mounted device 10 is OFF and the storage unit 3c has already been stored with the maintenance notification information of the accumulation type.

When the power supply of the vehicle-mounted device 10 is turned ON (step S111), the control unit 4 determines whether the storage unit 3c is stored with the maintenance notification information or not (step S112).

When the control unit 4 determines that the maintenance notification information is not stored in the storage unit 3c (step S112; NO), the control unit 4 terminates this process.

On the other hand, when the control unit 4 determines that the maintenance notification information is stored in the storage unit 3c (step S112; YES), the control unit 4 determines whether the target vehicle C has reached the maintenance timing or not (step S113). The determination of whether it has reached the maintenance timing or not is made based on the prescribed setting value included in the maintenance notification information. Provided that, for example, the setting value is 5000 km in the maintenance notification information for notifying oil exchange. In this case, the control unit 4 determines whether the driving distance after the oil exchange is at least 5000 km or not. When the control unit 4 determines that the driving distance after the oil exchange is at least the set value of 5000 km, it is also to be determined that the target vehicle C has reached the maintenance timing.

When the control unit 4 determines that the target vehicle C has not reached the maintenance timing yet (step S113; NO), the control unit 4 finishes this process.

On the other hand, when the control unit 4 determines that the target vehicle C has already reached the maintenance timing (step S113; YES), the control unit 4 displays the maintenance notification information on the display unit 1e (step S114), and finishes this process.

As described above, according to this embodiment, the center apparatus 30 can produce the maintenance notification information with respect to each vehicle-mounted device 10 on the basis of (4) the cumulative driving distance information and the maintenance history information preliminarily stored in the center apparatus 30 in the uplink information transmitted from the vehicle-mounted device 10. The center apparatus 30 can transmit the produced maintenance notification information to the vehicle-mounted device 10. Therefore, the vehicle-mounted device 10 can acquire the required information having separately been produced.

The maintenance history information includes the inspection timing information concerning the target vehicle C. The center apparatus 30 can produce the maintenance notification information for notifying the target vehicle C of the inspection timing on the basis of the uplink information and maintenance history information. Accordingly, the vehicle-mounted device can acquire the maintenance notification information for notifying the inspection timing, which has separately been produced.

The maintenance history information also includes the exchange timing information concerning the target vehicle C. The center apparatus 30 can produce the maintenance notification information for notifying the target vehicle C of the timing of exchanging consumables on the basis of the uplink information and the maintenance history information. Accordingly, the vehicle-mounted device 10 can acquire the maintenance notification information for notifying the exchange timing, which has separately been produced.

Since the vehicle-mounted device 10 includes the display unit 1e, the acquired maintenance notification information can be displayed on the display unit 1e. This allows the user to easily grasp the inspection timing and the timing of exchanging consumables of the target vehicle C.

The vehicle-mounted device 10 can display the maintenance notification information of the direct type on the display unit 1e, and also display the maintenance notification information of the accumulation type on the display unit 1e after the lapse of the prescribed time period. This allows the vehicle-mounted device 10 to display the maintenance notification information on the display unit 1e at an appropriate timing even when receiving the maintenance notification information of any one of the direct type and the accumulation type. Accordingly, the user can easily gasp the inspection timing and the timing of exchanging consumables of the target vehicle C.

1. An information distributing system in which a vehicle-mounted device is mounted on each of one or more vehicles and connected to a center apparatus via a roadside wireless device in a manner capable of making wireless communication,
wherein the vehicle-mounted device comprises: a first communication unit adapted to communicate with the center apparatus via the roadside wireless device; a first storage unit adapted to store driving information of the vehicle mounted with the vehicle-mounted device; and a first control unit adapted to read the driving information from the first storage unit and causing the first communication unit to transmit the information to the center apparatus, and
wherein the center apparatus comprises: a second communication unit adapted to communicate with the vehicle-mounted device via the roadside wireless device; a second storage unit adapted to store maintenance history information of the vehicle in association with the vehicle-mounted device mounted on the vehicle; and a second control unit adapted to produce maintenance notification information for notifying maintenance timing of the vehicle on the basis of the driving information transmitted from the vehicle-mounted device and the maintenance history information read from the second storage unit and causing the second communication unit to transmit the produced maintenance notification information to the vehicle-mounted device of the vehicle.

2. The information distributing system according to claim 1, wherein the maintenance history information includes a history of inspection timing when an inspection has previously been executed, and the second control unit produces maintenance notification information for notifying inspection timing of the vehicle on the basis of the driving information and the maintenance history information and causes the second communication unit to transmit the produced maintenance notification information to the vehicle-mounted device.

3. The information distributing system according to claim 1, wherein the maintenance history information includes an exchange history of exchanging consumables of the vehicle, and the second control unit produces maintenance notification information for notifying timing of exchanging consumables of the vehicle on the basis of the driving information and the maintenance history information and causes the second communication means unit to transmit the produced maintenance notification information to the vehicle-mounted device of the vehicle.

4. The information distributing system according to claim 1, wherein the vehicle-mounted device comprises display unit, and
the first control unit causes the display unit to display the maintenance notification information transmitted from the center apparatus.

5. The information distributing system according to claim 1, wherein the first control unit causes the first storage unit to temporarily store the maintenance notification information transmitted from the center apparatus, and causes the display unit to display the information after a lapse of a prescribed time period.

6. A vehicle-mounted device mounted on each of one or more vehicles and connected to a center apparatus via a roadside wireless device in a manner capable of making wireless communication, the vehicle-mounted device comprising:
a communication unit adapted to communicate with the center apparatus via the roadside wireless device;
a storage unit adapted to store driving information of the vehicle mounted with the vehicle-mounted device; and
a control unit adapted to read the driving information from the storage unit and causing the communication unit to transmit the information to the center apparatus.
